(19) United States
(12) Patent Application Publication
(10) Pub. No.: US 2023/0394901 A1
(43) Pub. Date: Dec. 7, 2023

(54) SECURING ELECTRONIC BALLOT SYSTEMS VIA SECURE MEMORY DEVICES WITH EMBEDDED HARDWARE SECURITY MODULES

(71) Applicant: Micron Technology, Inc., Boise, ID (US)

(72) Inventors: Sourin Sarkar, Bangalore (IN); Vamshikrishna Komuravelli, Rangareddy (IN); Spandana Patchigolla, Hyderabad (IN)

(21) Appl. No.: 17/859,892

(22) Filed: Jul. 7, 2022

Related U.S. Application Data
(60) Provisional application No. 63/348,411, filed on Jun. 2, 2022.

(51) Int. Cl. G07C 13/00; H04L 9/32; G06K 19/06

(52) U.S. Cl. CPC G07C 13/00; H04L 9/3236; G06K 19/06028; H04L 2209/463

(57) ABSTRACT

In some aspects, the techniques described herein relate to a method including: receiving, by an electronic voting machine (EVM), user data from a user device, the user data including a unique code; presenting, by the EVM, an interface, the interface capable of receiving a vote; generating, by the EVM, a command based on the user data and the vote; determining, by the EVM, that the command is valid; encrypting, by the EVM, the vote and the user data; and writing, by the EVM, the vote to a secure memory.

### RELATED APPLICATIONS

The present application claims priority to Prov. U.S. Pat. App. Ser. No. 63/348,411 filed Jun. 2, 2022, the entire disclosures of which application are hereby incorporated herein by reference.

### BACKGROUND

Current voting systems generally simplistic devices to tally votes of citizens. Elections and voting are necessarily highly localized events. In most deployments, once a voter casts a vote electronically at a local voting center using an electronic voting machine (EVM), the cast vote is stored in the EVM. As the events are localized to voting centers it is very difficult to ascertain if an individual voter is exercising his/her voting rights at multiple locations. Tampering attacks (e.g., via a side channel attack) can modify or corrupt the content stored in EVM memory. Recast attacks can modify vote counts by replaying a vote casting event through careful and malicious orchestration of the casting session.

### BRIEF DESCRIPTION OF THE DRAWINGS

FIG. 1 is a block diagram of an electronic voting system (EVS) according to some of the example embodiments.

FIG. 2 is a flow diagram illustrating a method for generating a unique casting code according to some of the example embodiments.

FIG. 3 is a flow diagram illustrating a method for provisioning an EVM according to some of the example embodiments.

FIG. 4 is a flow diagram illustrating a system for casting a vote using an EVM according to some of the example embodiments.

FIG. 5 is a block diagram of a computing device according to some embodiments of the disclosure.

### DETAILED DESCRIPTION

The example embodiments remedy the above, and other, problems in the existing art of EVMs. In the example embodiments, a method, system, and computer-readable media for protecting an electronic ballot system (EBS) is described. To address the aforementioned security vulnerabilities, the example embodiments secure an EBS against tampering attacks and recast attacks by utilizing a secure memory element that has an embedded hardware security module (HSM). The example embodiments provide a low-cost hardware driven embedded security system central to the EBS. This creates a reliable, robust, and secure system with minimal vulnerability.

The example embodiments use software, firmware, and hardware security to achieve these security goals. As a result, the example embodiments can ensure the singularity of a vote, ensure that the vote is protected against tamper and replay or recast attacks, and ensure secure anonymous vote traceability for a voter verifiable vote. The example embodiments accomplish this by generating a unique casting code tied to a voter from a centralized trusted authority. In some embodiments, the casting code can incorporate verified user biometrics. The example embodiments further provide techniques for securely casting a vote on an EVM. The example embodiments further describe generating a secure hash casting confirmation code specific to a voter. The example embodiments further describe the secure recording of each vote transaction. The example embodiments further describe a tamper-proof secure memory protected by an embedded HSM. Finally, the example embodiments describe a secure vote object wherein once a vote is cast it cannot be rescinded, changed, or recast.

In some aspects, the techniques described herein relate to a method including: receiving, by an electronic voting machine (EVM), user data from a user device, the user data including a unique code; presenting, by the EVM, an interface, the interface capable of receiving a vote; generating, by the EVM, a command based on the user data and the vote; determining, by the EVM, that the command is valid; encrypting, by the EVM, the vote and the user data; and writing, by the EVM, the vote to a secure memory.

In some aspects, the techniques described herein relate to a method, wherein receiving user data includes scanning a quick response (QR) code.

In some aspects, the techniques described herein relate to a method, wherein receiving user data includes recording an image of one or more text strings.

In some aspects, the techniques described herein relate to a method, wherein generating a command includes signing the command with a signing key, the signing key generated in part on the user data.

In some aspects, the techniques described herein relate to a method, wherein the signing key is further generated in part on a root key stored in the secure memory of the EVM.

In some aspects, the techniques described herein relate to a method, wherein determining if the command is valid includes computing a hash of the user data and determining if a matching hash exists in the secure memory.

In some aspects, the techniques described herein relate to a method, further including writing the hash to the secure memory if a matching hash does not exist.

In some aspects, the techniques described herein relate to a non-transitory computer-readable storage medium for tangibly storing computer program instructions capable of being executed by a computer processor, the computer program instructions defining steps of: receiving, by an electronic voting machine (EVM), user data from a user device, the user data including a unique code; presenting, by the EVM, an interface, the interface capable of receiving a vote; generating, by the EVM, a command based on the user data and the vote; determining, by the EVM, that the command is valid; encrypting, by the EVM, the vote and the user data; and writing, by the EVM, the vote to a secure memory.

In some aspects, the techniques described herein relate to a non-transitory computer-readable storage medium, wherein receiving user data includes scanning a quick response (QR) code.

In some aspects, the techniques described herein relate to a non-transitory computer-readable storage medium, wherein receiving user data includes recording an image of one or more text strings.

In some aspects, the techniques described herein relate to a non-transitory computer-readable storage medium, wherein generating a command includes signing the command with a signing key, the signing key generated in part on the user data.

In some aspects, the techniques described herein relate to a non-transitory computer-readable storage medium, wherein the signing key is further generated in part on a root key stored in the secure memory of the EVM.

In some aspects, the techniques described herein relate to a non-transitory computer-readable storage medium, wherein determining if the command is valid includes computing a hash of the user data and determining if a matching hash exists in the secure memory.

In some aspects, the techniques described herein relate to a non-transitory computer-readable storage medium, further including writing the hash to the secure memory if a matching hash does not exist.

In some aspects, the techniques described herein relate to a device including: a secure memory; and a processor configured to: receive user data from a user device, the user data including a unique code; present an interface capable of receiving a vote; generate a command based on the user data and the vote; determine that the command is valid; encrypt the vote and the user data; and write the vote to the secure memory.

In some aspects, the techniques described herein relate to a device, wherein receiving user data includes scanning a quick response (QR) code.

In some aspects, the techniques described herein relate to a device, wherein receiving user data includes recording an image of one or more text strings.

In some aspects, the techniques described herein relate to a device, wherein generating a command includes signing the command with a signing key, the signing key generated in part on the user data.

In some aspects, the techniques described herein relate to a device, wherein the signing key is further generated in part on a root key stored in the secure memory.

In some aspects, the techniques described herein relate to a device, wherein determining if the command is valid includes computing a hash of the user data and determining if a matching hash exists in the secure memory.

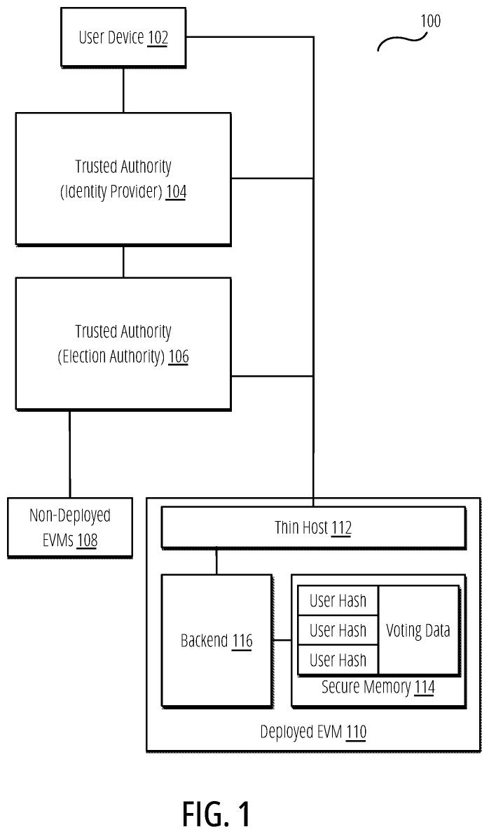

FIG. 1 is a block diagram of an electronic voting system (EVS) according to some of the example embodiments.

In an embodiment, system 100 includes a user device 102, identity provider 104, election authority 106, non-deployed EVMs 108, and a deployed EVM 110.

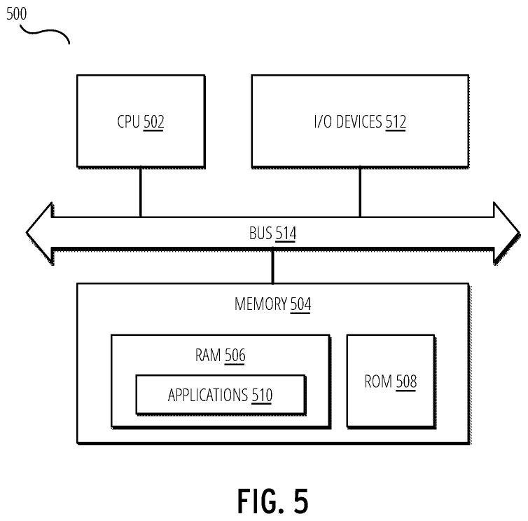

In an embodiment, the user device 102 can comprise a mobile device or similar type of portable device that can be carried to a voting location housing, for example, deployed EVM 110. In another embodiment, the user device 102 can comprise a shared terminal near to deployed EVM 110. In general, the user device 102 may be communicatively coupled to a wide area network (WAN) so as to access the identity provider 104 which may comprise a central repository of user identity data. Example components of the user device 102 are depicted in FIG. 5 and not repeated herein.

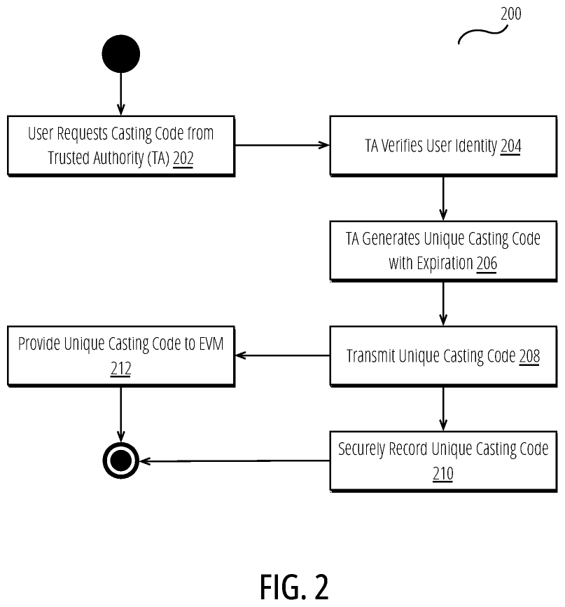

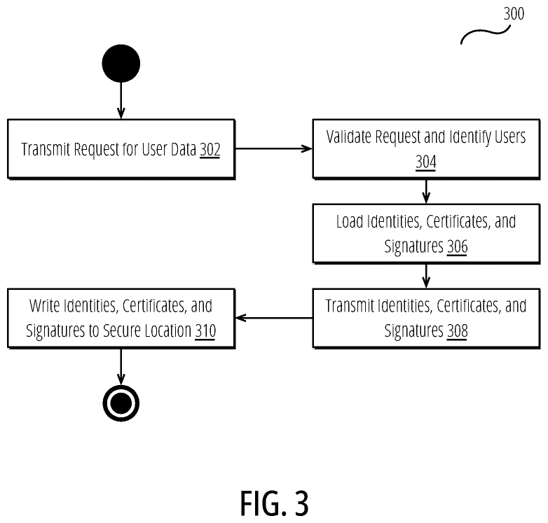

System 100 further includes an identity provider 104. In some embodiments, the identity provider 104 can comprise a computing device (as depicted in FIG. 5) or network of such computing devices. In some embodiments, the identity provider 104 can include a database or other data storage device that stores user identity data as well as digital certificates and digital signatures associated with users. In some embodiments, the data managed by identity provider 104 can be verified by a government entity, thus operating as a single source of truth for user identities. In some embodiments, the identity provider 104 can be equipped with one or more servers for generating unique codes for users when voting. Details of this process are described in FIG. 2 and not repeated herein. Further, in some embodiments, identity provider 104 can be equipped with one or more server that enable provisioning of EVMs by preloading user data to the EVMs, as described in FIG. 3 and not repeated herein.

System 100 further includes an election authority 106. In some embodiments, the election authority 106 can comprise a computing device (as depicted in FIG. 5) or network of such computing devices. In some embodiments, election authority 106 can be configured to manage EVMs. In some embodiments, the election authority 106 can preload user data onto non-deployed EVMs 108 to provision such EVMs prior to an election. Details of the provisioning process are provided in FIG. 3 and not repeated herein.

System 100 includes non-deployed EVMs 108 and deployed EVM 110. In general, non-deployed EVMs 108 and deployed EVM 110 may be structurally identical. However, deployed EVM 110 represents an EVM preloaded with user data (as per FIG. 3) and deployed at a voting site or similar location.

A given EVM (including non-deployed EVMs 108 and deployed EVM 110) includes a secure memory 114 for storing sensitive data. In some embodiments, the secure memory 114 can include a hardware security module (HSM), trusted execution environment (TEE), secure enclave, or similar type of hardware-enforce security mechanism to store data securely. As illustrated, the secure memory 114 can store user hashes (to prevent re-casting of votes) as well as actual voting data recorded for each user. Details of accessing and managing secure memory 114 are provided in the description of FIG. 5 and are not repeated herein.

In some embodiments, a given EVM can include a tamper detection mechanism to ensure the integrity of the data stored in the secure memory 114. In some embodiments, the tamper detection mechanism can measure a tamper protection perimeter (e.g., a combination of hardware, firmware, or software that must be secured) and compare this measurement to a golden measurement of the expected tamper protection perimeter stored in the secure memory. The specific perimeter can be defined according to the needs of the EVM or operator of the EVM. To maintain the tamper detection mechanism, each EVM can include an ultra-low power source (not illustrated) to ensure that the mechanism can run continuously. In some embodiments, this ultra-low power source can comprise a power source that can maintain a fixed power output for a predetermined period of time (e.g., three to six months). In some embodiments, the election authority 106 can replace the power source when reprovisioning the EVM. In an embodiment, upon detecting a tamper attack, the tamper detection mechanism can destroy all cryptographic data (e.g., keys) that can be used to extract the data from the secure memory. As a result, the tamper detection mechanism can render the EVM useless, even if dumped using an external memory chip reader.

In an embodiment, an EVM includes components to prevent re-casting of votes. In an embodiment, the EVM can include a thin host 112, a backend 116, and the secure memory 114 (described above). In an embodiment, a user interacts with a user interface (UI) of the EVM and the inputs are processed by the thin host 112. In an embodiment, the thin host 112 verifies the user identity. In an embodiment, once the user identity is verified, the inputs are passed onto the backend 116 that is responsible for storing the information about the user and the vote in the secure memory 114. In an embodiment, the communication between the backend 116 and the secure memory 114 is through an encrypted channel to prevent any snooping attacks or MITM (Man-in-the-Middle) attack.

Various operations of system 100 are described in the following FIGS. 2 through 5, the disclosure of which is not repeated herein.

FIG. 2 is a flow diagram illustrating a method for generating a unique casting code according to some of the example embodiments.

In step 202, method 200 can include a user requesting a casting code from a trusted authority. Details of the trusted authority were provided previously and are not repeated herein.

In some embodiments, a user can request a casting code via a mobile device, EVM, or other type of computing device. In some embodiments, the trusted authority can store verified data describing a user. For example, the trusted authority can store biometric data verified as being associated with user (e.g., as represented by name, social security number, passport number, etc.). The specifics on how a trusted authority can obtain verified user data is not limiting and other types of verified data can be obtained.

In step 202, a user can supply one or more items of identifying data to the trusted authority for verification. For example, a mobile device or other personal computing device can obtain a fingerprint scan, image of the user's face, iris scan, etc. as biometric data to upload to the trusted authority. In some embodiments, the user (in step 202) can also provide their purported identity (e.g., name, social security number, passport number, address, etc.) along with the identifying data (e.g., biometric data) to the trusted authority. In some embodiments, the trusted authority can expose an endpoint (e.g., Hypertext Transfer Protocol, HTTP, endpoint) to receive such requests.

In step 204, method 200 can include the trusted authority verifying the identity of the user. In some embodiments, step 204 can include the trusted authority comparing stored identifying data (e.g., biometrics) to the identifying data (e.g., biometrics) included in the request of step 202. In some embodiments, step 204 can include the trusted authority querying a database of users using the purported identity (e.g., name, social security number, passport number, address, etc.) and loading the stored identifying data in response to compare to the received identifying data. In some embodiments, if method 200 cannot confirm the identifying data of the user, method 200 can return an error code or similar response to indicate as such (not illustrated).

In step 206, method 200 can include the trusted authority generating a unique casting code with an expiration date. In some embodiments, the casting code can comprise a unique alphanumeric code. In other embodiments, the casting code can comprise a quick response (QR) code encapsulating a unique value (i.e., a unique alphanumeric code). As used herein, a “unique” code may refer to a code not previously issued by other invocations of method 200. Alternatively, a “unique” may refer to a code not previously issued by other non-expired codes issued by invoking method 200. In some embodiments, the unique casting code can be generated using a random or pseudorandom number generator or similar source of randomness. As will be discussed, generated casting codes can be stored to ensure uniqueness.

In some embodiments, the unique casting code is a one-time or single use use code. To enforce one-time or single use, method 200 can include a short expiration period (e.g., ten minutes). The specific expiration period used is not limiting. For example, if the user is instructed to obtain the unique casting code while using an EVM, the short expiration period can be set to an average duration of voting. In some embodiments, the expiration period can be included

In some embodiments, the casting code can include further information regarding the user. For example, the casting code can include the confirmed identifying data (e.g., biometric data) of the user (in condensed and/or encrypted form). Further, in some embodiments, the casting code can include user demographic data (e.g., name, address, ethnicity, etc.). Further, in some embodiments, the casting code can include the polling location data of the user. These, and other data, can be included along with the unique code discussed above. In some embodiments, when transmitting in text, each item of data (e.g., unique code, biometric data, etc.) can be transmitted as separate text strings. In other embodiments, they can be combined into a single string.

In step 208, method 200 can include transmitting the unique casting code to the user. In some embodiments, the form of the unique casting code may be selected based on the type of device issuing the request in step 202. For example, if the user requests the casting code via a short message service (SMS), method 200 can generate a unique alphanumeric code and return the unique alphanumeric code to the user via SMS. Alternatively, if the user requests the unique casting code via a data channel (e.g., using an internet connection), method 200 can transmit an image of a QR code encapsulating the unique alphanumeric code.

In step 210, method 200 can include securely recording the unique casting code. In some embodiments, the trusted authority can maintain a secure storage device for persisting unique codes generated in step 206. In some embodiments, the trusted authority can be associated users with the unique codes (and expirations) for later use (e.g., during audits, recounts, etc.) including verifying votes.

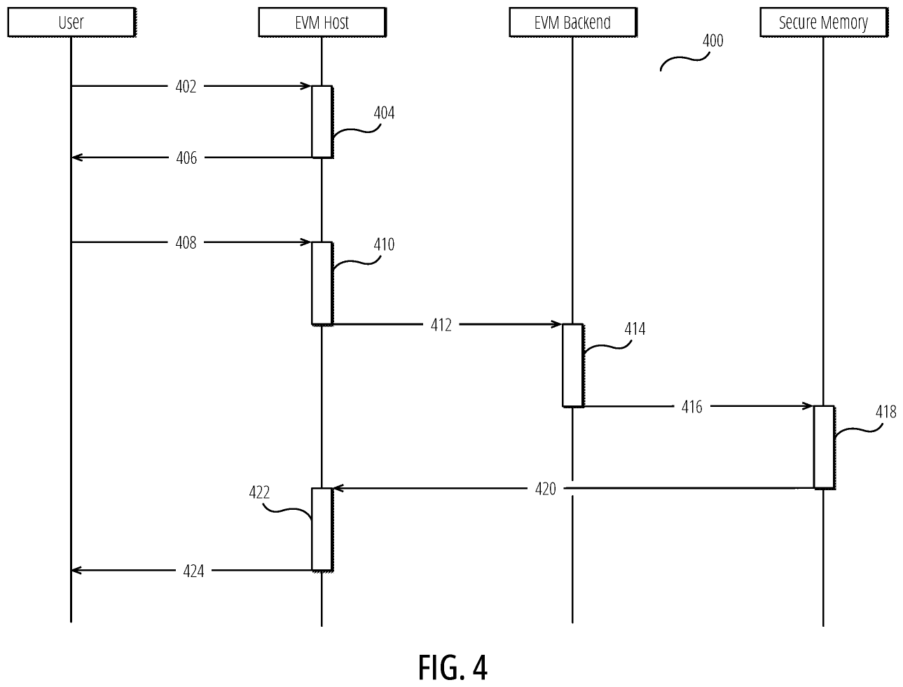

In step 212, method 200 can include the user providing the unique casting code to an EVM to initiate a voting process as will be discussed in more detail in FIG. 4.

FIG. 3 is a flow diagram illustrating a method for provisioning an EVM according to some of the example embodiments.

In step 302, method 300 can include transmitting a request for user data. In some embodiments, the request in step 302 can be issued by an election commission or other type of organization responsible for provisioning EVMs. In some embodiments, the EVM itself can issue the request. In other embodiments, an intermediary computer system can issue the request. In some embodiments, the request includes location data of the EVM. For example, the request can include data describing the deployment of the EVM (e.g., voting region, state, district, ward, etc.). In some embodiments, the EVM may be a new EVM or a re-used EVM (e.g., an EVM that was previously used in an election). In some embodiments, as part of step 302, the entity issuing the request in step 302 can replace the ultra-low power source of the EVM as described in FIG. 1.

In step 304, method 300 can include a trusted authority receiving the request and validating it. In some embodiments, step 304 can include validating a digital certificate or similar cryptographic data to confirm that the sender is trusted. In some embodiments, step 304 can include decrypting the data included in the request (if encrypted) using a public key of a known entity (e.g., election commission).

In some embodiments, step 304 can also include identifying one or more users for the request. As discussed, in some embodiments, the EVM can include location data and method 300 can use this location to identify users associated with the location. In some embodiments, this can comprise all users registered to vote based on the geographic location. For example, the request can include a voting ward district identifier and step 304 can include identifying all registered voters in that voting ward based on, for example, user demographic data such as a current registered residential address.

In step 306, method 300 can include loading user identities, certificates, and signatures of the users identified in step 304. In an embodiment, the user identify can include the data included in the QR or unique alphanumeric codes described in FIG. 2 and not repeated herein. Thus, in some embodiments, the trusted authority can access a database of user identity data and load this data for the identified users. Further, in some embodiments, the trusted authority can maintain (or otherwise access) a database of verified cryptographic data for users. In some embodiments, this cryptographic data can comprise digital certificates and digital signatures. In some embodiments, each user is associated with a digital certificate and a digital signature for signing transactions. In some embodiments, these digital certificates and signatures can be provided by a government organization for the users.

In step 308, method 300 can include transmitting the identities, certificates, and signatures to the requesting device. In some embodiments, the identities, certificates, and signatures can be transmitted over a secure channel as a response to the request (e.g., HTTP response).

In step 310, method 300 can include writing the identities, certificates, and signatures to a secure memory of the EVM. In some embodiments, the secure memory can comprise an HSM or similar device. In some embodiments, step 310 can include erasing any previously stored identities, certificates, and signatures or otherwise overwriting any other previously stored identities, certificates, and signatures. In some embodiments, the secure memory is tamper proof and thus once written the EVM can ensure the integrity of the identities, certificates, and signatures for a given EVM.

In some embodiments, a given EVM may not have WAN during provisioning connectivity. In such an environment, a Local Authentication Device (LAD) can be used to verify user identities. In an embodiment, the LAD can comprise similarly structured device that includes a tamper proof perimeter and can persistently store identities, certificates, and signatures using the method 300. In some embodiments, the LAD may or may not include WAN connectivity of its own. In some embodiments, the localized device can sync the data back to the election authority when there is a valid network connectivity. In some embodiments, the LAD includes local area network (LAN) connectivity. In some embodiments, the LAD can be communicatively coupled to one or more EVMs via a LAN. In such embodiment, when an EVM attempts to access a secure memory device, the EVM can forward the communications over the LAN to a LAD. The EVM thus treats the LAD as a secure memory, albeit remote from the EVM. In some embodiments, this architecture can help the recast protection to detect an inadvertent or malicious attempt to recast a vote using another local EVM within a short span of time.

FIG. 4 is a flow diagram illustrating a system for casting a vote using an EVM according to some of the example embodiments.

In step 402, method 400 can include a user providing voting data to an EVM via a thin host layer of the EVM. As discussed in FIG. 2, the voting data can include a unique code, user biometric data, etc. as stored in a QR code or alphanumeric strings. In some embodiments, the user can provide the voting data to the EVM by displaying the voting data on a mobile device wherein the thin host layer can record an image of the voting data and convert the image to processible data (e.g., QR code recognition, text recognition, etc.).

In step 404, method 400 can include verifying the user's identity. In an embodiment, step 404 can include comparing identifying data of the user included in the voting data to stored locally by the EVM. In an embodiment, the request can include identifying data received with an expiration as described in FIG. 2. Similarly, the EVM can store known identifying data of users during the provisioning process as described in FIG. 3. As such, in step 404, method 400 can compare the received data to the stored data to ensure that only authorized users (e.g., voters) are casting votes in the following steps.

In step 406, method 400 can include transmitting a response to the user. If the result of step 404 is a success, method 400 can include instructing the user to continue voting. In some embodiments, method 400 can include presenting a voting UI or other type of interface allowing the user to cast a vote. In some embodiments, method 400 can include displaying a timer or other countdown value associated with the expiration of the voting data.

In step 408, method 400 can include receiving a vote. The specific form of a vote is not limiting, and any computer-readable form may be used. For example, user can select a candidate or ballot measure via a UI and the vote can be represented as a bitstring identifying the user's choices.

In step 410, method 400 can include generating a voting command. In an embodiment, the voting command can include the user identity and biometric data as well as the vote data received in step 408. In some embodiments, the voting command can be signed by the EVM in step 410. In some embodiments, an asymmetric signature algorithm can be used to sign the voting command. In an embodiment, an Elliptic Curve Cryptography (ECC) algorithm, such as an Elliptic Curve Digital Signature Algorithm (ECDSA) algorithm, can be used. In such an embodiment, when the secure memory is delivered to the election authority for deployment in EVMs, the secure memory can include a private key derived from a physically unclonable function (PUF), such as a static random-access memory (SRAM) included in the device. As part of FIG. 3, the election authority can enable the memory device by provisioning and enabling the secure memory. Once the provisioning has been done, the election authority can write a root key in a key store of the secure memory (e.g., in an HSM). At this point the secure memory store is owned by the election authority.

In step 410 (and other steps), a unique signature can be created for signing the secure transactions of any given user. As one example, the key to sign the secure transactions can be derived as follows:

SigningKey=F(biometrics,identity,EVM fingerprint,key) Equation 1

In Equation 1, F represents the key generation algorithm (e.g., ECC), biometrics represents the voting user's biometric data, identity represents the user's identify (e.g., demographic data), fingerprint represents a unique fingerprint of the given EVM (e.g., based on measurements of unique hardware, firmware, or software of the EVM), and key represents the root key (e.g., public portion) as written by the election authority to the secure memory. In some embodiments, the above signing key can be computed each time a user votes. Given the user of a key generated by the election authority and securely stored, the signing key can be guaranteed to be secure. As such, in step 410 (and other steps), the signing key can be used as follows to sign data (such as a voting command): signature=ECDSA(Data,SigningKey), where ECDSA represents an ECDSA algorithm and Data represents the data to sign (e.g., a voting command).

In step 412, method 400 can include transmitting the signed command to the EVM backend and, in step 414, method 400 can include the EVM backend receiving the signed command and verifying the signature.

In some embodiments, as part of step 414, the EVM backend can regenerate the signature key using the above process and data stored in the secure memory and can validate the received signature using the generated command. If the validation fails, method 400 can include transmitting an error response to the EVM thin host which prevents the recording of the vote (not illustrated). In some embodiments, step 412 can include determining if the user has already voted (i.e., detecting if a re-cast event is occurring).

In an embodiment, step 414 can also include computing a first hash for a given user. In some embodiments, this first hash can be computed using the user identity and biometric data included in the voting command. In some embodiments, the user identity and biometric data may be represented as an alphanumeric string and step 414 can include using a well-defined hash function (e.g., SHA-256) to compute a hash of the user identity and biometric data (e.g., concatenation of the data). In some embodiments, step 414 can then comprise querying (step 416) a database of stored hashes to identify a matching hash for the first hash returned by the secure memory. If no such matching hash is found by the secure memory (step 418), the secure memory can write (step 418) the first hash to the database of stored hashes. Alternatively, if the EVM determines that a matching hash exists, the EVM can stop processing and prevent the user from casting a vote, thus ensuring once a user votes, the user can no longer vote (until the EVM is reprovisioned using method 300). In some embodiments, the database of stored hashes is stored in the secure memory to prevent tampering as described above. In some embodiments, the EVM backend can also encrypt the vote and store the vote in secure location as part of steps 416 and 418. In some embodiments, the EVM can use keys stored in the secure memory (generated by an election authority) to encrypt the vote data.

In step 420, method 400 can include the secure memory transmitting a response to the EVM thin host. In some embodiments, the response includes a success or failure response based on the foregoing processing (e.g., a success response if the vote was recorded and a failure message otherwise). In step 422, method 400 can include the EVM thin host generating a completion code. In some embodiments, the completion code can comprise any unique alphanumeric value generated by the EVM to confirm a vote. In some embodiments, the EVM can transmit the completion code to the election authority via a wide area network or other type of network connection. In step 424, method 400 can include the EVM providing the completion code to the user for their records.

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 5, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

These computer program instructions can be provided to a processor of a general purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure a computer readable medium (or computer-readable storage medium) stores computer data, which data can include computer program code or instructions that are executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by an electronic voting machine (EVM), user data from a user device, the user data including a unique code;
presenting, by the EVM, an interface, the interface capable of receiving a vote;
generating, by the EVM, a command based on the user data and the vote;
determining, by the EVM, that the command is valid;
encrypting, by the EVM, the vote and the user data; and
writing, by the EVM, the vote to a secure memory.

2. The method of claim 1, wherein receiving user data comprises scanning a quick response (QR) code.

3. The method of claim 1, wherein receiving user data comprises recording an image of one or more text strings.

4. The method of claim 1, wherein generating a command comprises signing the command with a signing key, the signing key generated in part on the user data.

5. The method of claim 4, wherein the signing key is further generated in part on a root key stored in the secure memory of the EVM.

6. The method of claim 1, wherein determining if the command is valid comprises computing a hash of the user data and determining if a matching hash exists in the secure memory.

7. The method of claim 6, further comprising writing the hash to the secure memory if a matching hash does not exist.

8. A non-transitory computer-readable storage medium for tangibly storing computer program instructions capable of being executed by a computer processor, the computer program instructions defining steps of:
receiving, by an electronic voting machine (EVM), user data from a user device, the user data including a unique code;
presenting, by the EVM, an interface, the interface capable of receiving a vote;
generating, by the EVM, a command based on the user data and the vote;
determining, by the EVM, that the command is valid;
encrypting, by the EVM, the vote and the user data; and
writing, by the EVM, the vote to a secure memory.

9. The non-transitory computer-readable storage medium of claim 8, wherein receiving user data comprises scanning a quick response (QR) code.

10. The non-transitory computer-readable storage medium of claim 8, wherein receiving user data comprises recording an image of one or more text strings.

11. The non-transitory computer-readable storage medium of claim 8, wherein generating a command comprises signing the command with a signing key, the signing key generated in part on the user data.

12. The non-transitory computer-readable storage medium of claim 11, wherein the signing key is further generated in part on a root key stored in the secure memory of the EVM.

13. The non-transitory computer-readable storage medium of claim 8, wherein determining if the command is valid comprises computing a hash of the user data and determining if a matching hash exists in the secure memory.

14. The non-transitory computer-readable storage medium of claim 13, further comprising writing the hash to the secure memory if a matching hash does not exist.

15. A device comprising:
a secure memory; and
a processor configured to:
receive user data from a user device, the user data including a unique code;
present an interface capable of receiving a vote;
generate a command based on the user data and the vote;
determine that the command is valid;
encrypt the vote and the user data; and
write the vote to the secure memory.

16. The device of claim 15, wherein receiving user data comprises scanning a quick response (QR) code.

17. The device of claim 15, wherein receiving user data comprises recording an image of one or more text strings.

18. The device of claim 15, wherein generating a command comprises signing the command with a signing key, the signing key generated in part on the user data.

19. The device of claim 18, wherein the signing key is further generated in part on a root key stored in the secure memory.

20. The device of claim 15, wherein determining if the command is valid comprises computing a hash of the user data and determining if a matching hash exists in the secure memory.
